(19) United States
(12) Patent Application Publication
(10) Pub. No.: US 2014/0047877 A1
(43) Pub. Date: Feb. 20, 2014

(54) DOOR HANDLE ASSEMBLY FOR A VEHICLE

(71) Applicants: Günther Böhm, Walting (DE); Georg Hochholzer, Beilngries (DE)

(72) Inventors: Günther Böhm, Walting (DE); Georg Hochholzer, Beilngries (DE)

(73) Assignee: Audi AG, Ingolstadt (DE)

(21) Appl. No.: 13/981,878

(22) PCT Filed: Dec. 17, 2011
(86) PCT No.: PCT/EP2011/006401

§ 371 Date: Oct. 10, 2013

(30) Foreign Application Priority Data
Jan. 26, 2011 (DE) 10 2011 009 524.1

(51) Int. Cl. E05B 65/12

(52) U.S. Cl. CPC E05B 81/16; E05B 85/107; E05B 83/36
USPC 70/275; 70/357

(57) ABSTRACT

Door handle assembly (1) for a vehicle, including a door handle (2) for actuating a door lock (6), which can be moved by external power from a level rest position to an exposed operative position, and a lock cylinder (3) placed adjacent to the door handle (2) for locking and unlocking a door lock (6). The lock cylinder (3) can be covered by a cover plate (4) which, when actuated by hand, exposes the lock cylinder (4) and allows switch of the door handle (2) from the rest position to the operative position.

Door handle assembly for a vehicle, including a door handle for actuating a door lock which can be moved by external power from a level rest position to an exposed operative position, and a lock cylinder placed adjacent to the door handle for locking and unlocking a door lock.

Such door handle assemblies are oftentimes used in vehicles for opening and closing of doors or hatches which are disposed in body openings. A level door handle is to be understood as relating to a door handle having a surface which in the rest position is flush with a surrounding body part. For allowing the door handle to be grasped by a user, the door handle must be moved, preferably by external power, from the rest position to an exposed operative position.

Such a door handle assembly is disclosed in generic DE 197 31 325 A1. The handle piece for opening the door is hereby arranged such that the outside of the handle piece is virtually flush in idle position with the outer contour of the door (level) and the handle piece can be switched for opening the door to an opening position in which the handle piece projects out in relation to the outer contour of the door. An adjuster unit is able to move the handle piece by external power into this opening position. Further arranged adjacent to the handle piece is a cylinder lock which is accessible from outside. The disclosed door handle assembly has the drawback that the cylinder lock cannot be attached in a concealed manner, so that the aesthetic benefits of a level handle piece is hereby partially lost again. This is particularly true in the case of a radio-based user identification that requires a cylinder lock only in exceptional cases. The same applies to the arrangement disclosed in EP 1 985 784 A1.

DE 298 04 105 U1 describes a handle for doors and hatches of motor vehicles, with a handle member which can be pivoted by a motor from a move-in position to a move-out position and has an undergrip zone which is situated in an inaccessible concealed disposition in the move-in position and is accessible only in the move-out position. A lock cylinder for a mechanical key is further provided in the undergrip zone, with the key being insertable only when the handle member is in move-out position. There is the drawback that the handle member can no longer be moved, when the motor drive fails and hence the lock cylinder is no longer reachable.

It is therefore an object of the present invention to provide a door handle assembly for a vehicle with level door handle and concealed lock cylinder, wherein the door handle can be removed from the level disposition by external power and also by hand.

This object is achieved by the features of claim 1.

Door handle assembly for a vehicle, including a door handle for actuating a door lock, which can be moved by external power from a level rest position to an exposed operative position, and a lock cylinder next to the door handle for locking and unlocking the door lock, wherein the lock cylinder can be covered by a cover plate, exposed by manually operating the cover plate, and the door handle can be moved from the rest position to the operative position.

As the cover plate normally covers the lock cylinder, an aesthetic look is realized when viewed from outside. In this state, the door handle can be moved by a radio-based authorization of the user through external power from a rest position to a operative position and the door lock is unlocked accordingly. The user can thus embrace the door handle and operate the door lock to open the door. After closing the door again, the door handle is returned to the rest position. In the event, the radio-based authorization fails or the operation by external power fails, the cover plate can be operated by hand in an exceptional case so that the lock cylinder is exposed to enable insertion of a mechanical key and the door handle is moved to the operative position at the same time. As a result, even in exceptional cases full functionality of the door handle assembly is provided, and yet a highest degree of aesthetic and aerodynamic advantages is maintained under normal circumstances. Furthermore, it is possible to particularly easily install the door handle assembly because the lock cylinder can easily be inserted and the door handle can be especially easily installed, when the cover plate is actuated. The use of the shown arrangement in doors is equally applicable for hatches in an analogous way. Therefore, in this context, doors are to be understood to also include hatches.

According to a preferred embodiment, the door handle assembly has means for approach detection, with the door handle being movable to the operative position when an authorized user approaches and the door lock is unlocked. These means for approach detection automatically sense the approach of an authorized user and thereby ensure a particularly high level of readiness of the door handle assembly. Such means for approach detection can be configured for example as radio receiver and/or capacitive sensor.

According to a preferred embodiment, the cover plate and the door handle interact via a deflection device. A mechanical deflection device is inexpensive and offers a very high reliability.

According to a preferred embodiment, the door handle can be switched by a deployment lever to the operative position, with a drive and the deflection device engaging on the deployment lever. The combined engagement of the deployment lever by the deflection device and drive decreases the number of parts and allows selective actuation of the deployment lever by hand or external power.

According to preferred embodiment, the drive has a first transmitting member to pull on the deployment lever. Suitable as first transmitting member is a cable pull which engages at a distance from the pivot axis of the deployment lever and pivots the latter. As an alternative, operating rods or a direct connection are possible. Resetting is implemented by spring force.

According to a preferred embodiment, actuation of the door handle is transferable via a second transmitting member to the door lock. A cable pull is especially suitable as second transmitting to transfer the pulling motion of the door handle to the door lock for release thereof.

According to preferred embodiment, the cover plate is swingable about a first pivot axis. The first pivot axis subdivides the cover plate hereby into first and second lever arms, with the first lever arm covering the lock cylinder and the second lever arm interacting with the deflection device. The manual operation of the cover plate is thus effected by applying pressure upon the second lever arm, rendering a particularly power saving operation of the deflection device possible.

According to preferred embodiment, the cover plate includes a flap and a faceplate.

The flap is hereby mounted for pivoting about the first pivot axis and supports the decorative faceplate.

A vehicle has at least a door or hatch including a door handle assembly according to the invention.

Further details and advantages of the invention will become apparent from the following description of a preferred embodiment with reference to the drawings.

It is shown in:

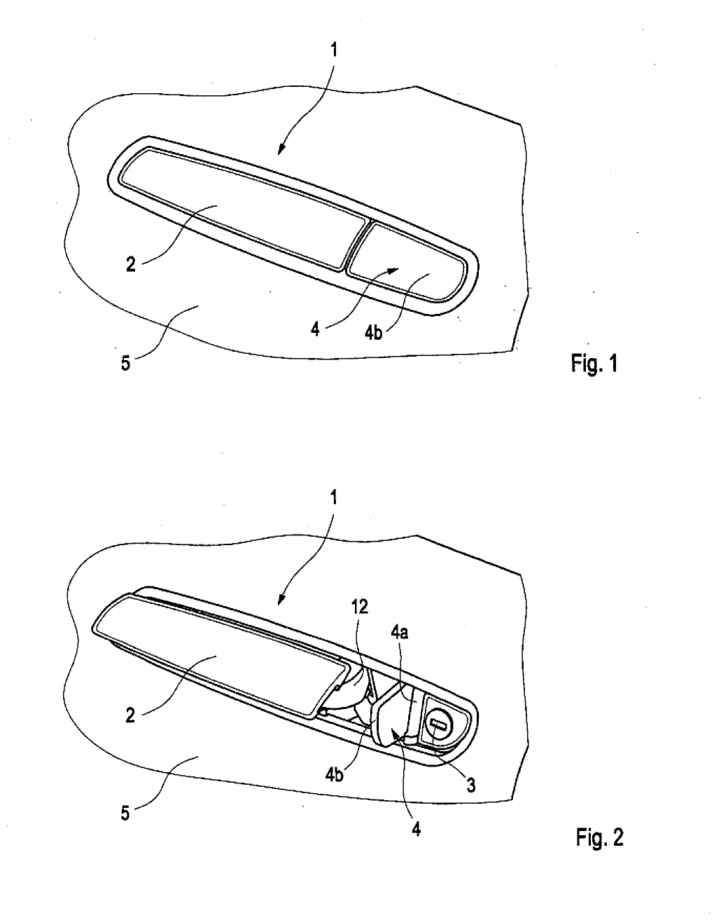

FIG. 1 a front view of a door handle assembly in rest position;

FIG. 2 a front view of a door handle assembly in operative position;

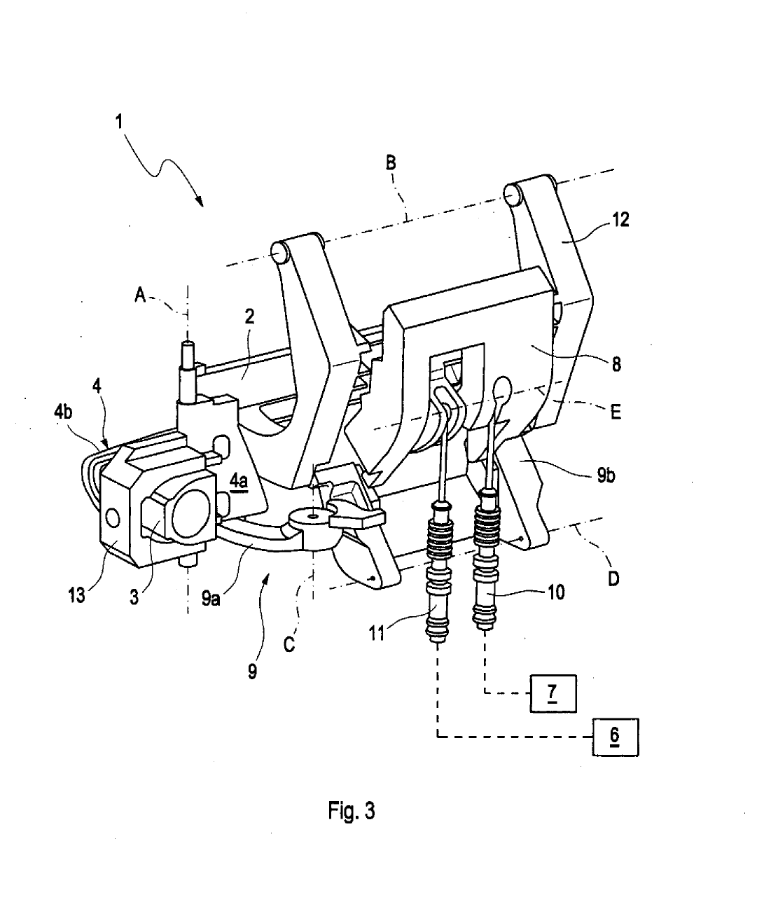

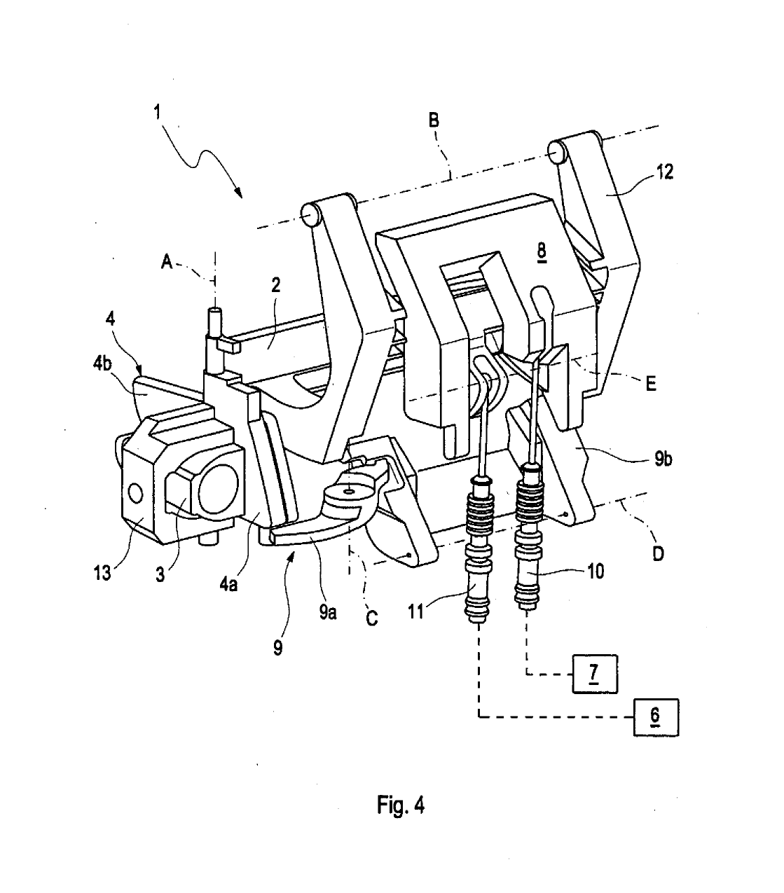

FIG. 3 a rear view of a door handle assembly in rest position;

FIG. 4 a rear view of a door handle assembly in operative position.

According to FIGS. 1 and 2, a door handle assembly 1 shows, when viewed from outside the vehicle, a level door handle 2 and an adjacent level cover plate 4, comprised of a flap 4a and a faceplate 4b arranged there above. The surfaces of the door handle 2 and the faceplate 4b run in a common plane with the surrounding door 5. The faceplate 4b covers the subjacent lock cylinder 3 in normal use, as shown in FIG. 1. In exceptional cases, in particular when moving the door handle 2 from the rest position to the operative position by way of external power fails, the cover plate 4 can be pivoted by hand to expose the lock cylinder 3 and thereby allow insertion of a mechanical key and switch of the door handle 2 at the same time to the operative position, as shown in FIG. 2.

According to FIGS. 3 and 4, a door handle assembly 1 shows, as viewed from its rear side, a door handle 2 which is carried by a handlebar 12 which is swingable about a second pivot axis B. The handlebar 12 can be pushed from a rest position to an exposed operative position by a deployment lever 8 which is swingable about a fifth pivot axis E. For that purpose, the deployment lever 8 is engaged by a first transmitting member 10 which can be acted upon by a drive 7 with a pulling force. A second transmitting member 11 engages the handlebar 12 to cause actuation of the door lock 6 for opening the door or hatch, when the door handle 21 assumes the operative position (see FIG. 4). Arranged next to the door handle 2 is a lock cylinder 3 which is held by a clip 13. The lock cylinder 3 can be covered by a cover plate 4 which is swingable about a first pivot axis A. The cover plate 4 is comprised of a flap 4a which carries a faceplate 4b. The faceplate 4b covers hereby the lock cylinder 3 and the flap 4a is swingably mounted. When the cover plate 4 is rotated by 90° from the normal position shown in FIG. 3, the flap 4 acts on a deflection device 9 in such a way that the door handle 2 is moved to the operative position (see FIG. 4). The flap 4a rotates hereby a deflection lever 9a about a third pivot axis C, which in turn pushes a manual deployment lever 9b, which is swingable about a fourth pivot axis D, against the handle bar 12.

### LIST OF REFERENCE SIGNS

A first pivot axis
B second pivot axis
C third pivot axis
D fourth pivot axis
E fifth pivot axis
1 door handle assembly
2 door handle
3 lock cylinder
4 cover plate
4a flap
4b faceplate
5 door (or hatch)
6 door lock
7 drive
8 deployment lever
9 deflection device
9a deflection lever
9b manual deployment lever
10 first transmitting member
11 second transmitting member
12 handlebar
13 clip

1.-10. (canceled)

11. A door handle assembly for a vehicle, comprising:
a door handle configured for actuating a door lock and movable by external power from a level rest position to an exposed operative position;
a lock cylinder adjacent to the door handle for locking and unlocking of the door lock; and
a cover plate configured for covering the lock cylinder and, when actuated by hand, exposes the lock cylinder to allow a switch of the door handle from the rest position to the operative position.

12. The door handle assembly of claim 11, further comprising an approach detection system configured to switch the door handle to the operative position, when an authorized user approaches, and the door lock is released.

13. The door handle assembly of claim 11, wherein the cover plate and the door handle interact via a deflection device.

14. The door handle assembly of claim 13, further comprising a deployment lever for switching the door handle to the operative position, with a drive and the deflection device engaging the deployment lever.

15. The door handle assembly of claim 14, wherein the drive is in pulling engagement with the deployment lever via a first transmitting member.

16. The door handle assembly of claim 15, further comprising a second transmitting member for transferring actuation of the door handle upon the door lock.

17. The door handle assembly of claim 11, wherein the cover plate is swingable about a first pivot axis.

18. The door handle assembly of claim 17, wherein the cover plate and the door handle interact via a deflection device, said first pivot axis subdividing the cover plate into first and second lever arms, with the first lever arm covering the lock cylinder and the second lever arm interacting with the deflection device.

19. The door handle assembly of claim 11, wherein the cover plate is comprised of a flap and a faceplate.

20. A vehicle, comprising:
at least one door or hatch; and
a door handle assembly for opening and closing the door or hatch, said door handle assembly including a door handle configured for actuating a door lock and movable by external power from a level rest position to an exposed operative position, a lock cylinder adjacent to the door handle for locking and unlocking of the door lock, and a cover plate configured for covering the lock cylinder and, when actuated by hand, exposes the lock cylinder to allow a switch of the door handle from the rest position to the operative position.

21. The vehicle of claim 20, wherein the door handle assembly includes an approach detection system configured to switch the door handle to the operative position, when an authorized user approaches, and the door lock is released.

22. The vehicle of claim 20, wherein the cover plate and the door handle interact via a deflection device.

23. The vehicle of claim 22, further comprising a deployment lever for switching the door handle to the operative position, with a drive and the deflection device engaging the deployment lever.

24. The vehicle of claim 23, wherein the drive is in pulling engagement with the deployment lever via a first transmitting member.

25. The vehicle of claim 24, wherein the door handle assembly includes a second transmitting member for transferring actuation of the door handle upon the door lock.

26. The vehicle of claim 20, wherein the cover plate is swingable about a first pivot axis.

27. The vehicle of claim 26, wherein the cover plate and the door handle interact via a deflection device, said first pivot axis subdividing the cover plate into first and second lever arms, with the first lever arm covering the lock cylinder and the second lever arm interacting with the deflection device.

28. The vehicle of claim 20, wherein the cover plate is comprised of a flap and a faceplate.
